(19) United States
(12) Patent Application Publication
(10) Pub. No.: US 2021/0061006 A1
(43) Pub. Date: Mar. 4, 2021

(54) TIRE COMPONENT FROM RUBBER WITH LOWER SURFACE AREA SILICA

(71) Applicant: Compagnie Generale des Etablissements Michelin, Clermont-Ferrand (FR)

(72) Inventors: Olivier PIFFARD, Mauldin, SC (US); Raymond STUBBLEFIELD, Greenville, SC (US); Elizabeth L HOTALING, Greenville, SC (US)

(21) Appl. No.: 16/958,570

(22) PCT Filed: Dec. 20, 2018
(86) PCT No.: PCT/US2018/066775

§ 371 Date: Jun. 26, 2020

(30) Foreign Application Priority Data
Dec. 27, 2017 (US) PCT/US2017/068476

(51) Int. Cl. B60C 1/00; C08L 7/00; C08L 9/06; C08L 19/00; C08K 3/06; C08K 3/36

(52) U.S. Cl. CPC B60C 1/0016; C08L 7/00; C08L 9/06; C08K 2201/006; C08K 3/06; C08K 3/36; C08L 19/006

(57) ABSTRACT

A tire comprising a tire component formed from a cross-linkable rubber composition having a rubber component selected from the group consisting of natural rubber, a synthetic rubber and combinations thereof with between 50 phr and 80 phr of a silica reinforcement filler having a BET surface area of between 100 m²/g and 135 m²/g measured in accordance with ASTM D1993. The cross-linkable rubber composition further includes a silica coupling agent and a sulfur curing system comprising between 1 phr and 2 phr of sulfur and an accelerator in an amount to provide a ratio of the sulfur to the accelerator by weight of between 0.4 and 0.6.

### BACKGROUND OF THE INVENTION

### Field of the Invention

This invention relates generally rubber compositions useful for the manufacture of rubber articles and more particularly to those having lower surface area silica.

### Description of the Related Art

It is desirable to provide tires that have improved wear characteristics. Consumers prefer buying tires that provide high mileage before having to be replaced with new tires. Therefore tire designers seek new materials and/or new combinations of existing materials that will provide tires having improved wear characteristics.

It is known in the industry that tire designers must often compromise on certain characteristics of the tires they are designing. Changing a tire design to improve one characteristic of the tire will often result in a compromise; i.e., an offsetting decline in another tire characteristic. One such compromise exists with wear and processability of rubber compositions containing silica as a reinforcement filler. It is known that lowering the surface area of the silica used in a rubber composition for use in a tire will increase its processability but it will also reduce its wear resistance.

Tire designers and those conducting research in the tire industry continue to search for materials and/or combinations of materials that can break some of the known compromise. It would be desirable to break the compromise between wear and processability for rubber compositions that contain silica as the reinforcing filler.

### DETAILED DESCRIPTION OF PARTICULAR EMBODIMENTS

Particular embodiments of the present invention include rubber compositions and articles made from such rubber compositions including, for example, tires treads and undertreads for pneumatic and nonpneumatic tires. The rubber compositions include a rubber component selected from natural rubber and synthetic rubbers, especially those synthetic rubbers that are highly unsaturated. In addition to the rubber component, the rubber compositions disclosed herein further include a silica reinforcing filler having a BET surface area of between 100 m²/g and 135 m²/g measured in accordance with ASTM D1993. It has been found that the use of such silica reinforcing fillers in a suitable amount breaks the compromise between wear of a tire tread and the processability of the uncured rubber composition.

Such compositions are useful for the manufacture of tire components including, for example, those components found in the tire sidewall, those found in the bead area, those found in the tire crown and, as noted above, for tire treads. Other useful articles that can be formed from such rubber compositions include, for example, as conveyor belts, motor mounts, tubing, hoses and so forth. Particular embodiments of articles formed from such rubber compositions may be limited to at least a portion of the part of tire treads that contract the ground surface and in other embodiments may alternatively include the undertread or base, which is a layer of cushioning rubber under the ground-contacting portion of the tread. Such tread construction is known by those skilled in the art as cap and base construction. Useful tire treads may be manufactured from particular embodiments of the rubber compositions disclosed herein for passenger or light truck tires as well as, for example, heavy truck, aircraft tires, agricultural tires and other tires, both pneumatic and nonpneumatic.

As used herein, “phr” is “parts per hundred parts of rubber by weight” and is a common measurement in the art wherein components of a rubber composition are measured relative to the total weight of rubber in the composition, i.e., parts by weight of the component per 100 parts by weight of the total rubber(s) in the composition.

As used herein, elastomer and rubber are synonymous terms.

As used herein, “based upon” is a term recognizing that embodiments of the present invention are made of vulcanized or cured rubber compositions that were, at the time of their assembly, uncured. The cured rubber composition is therefore “based upon” the uncured rubber composition. In other words, the cross-linked rubber composition is based upon or comprises the constituents of the cross-linkable rubber composition.

Embodiments of the rubber compositions that are disclosed herein include a highly unsaturated diene rubber component. Diene elastomers are known to be those elastomers resulting at least in part, i.e., a homopolymer or a copolymer, from diene monomers, i.e., monomers having two double carbon-carbon bonds, whether conjugated or not.

Generally diene elastomers may be classified as either “essentially unsaturated” diene elastomers or “essentially saturated” diene elastomers. As used herein, essentially unsaturated diene elastomers are diene elastomers resulting at least in part from conjugated diene monomers, the essentially unsaturated diene elastomers having a content of such members or units of diene origin (conjugated dienes) that is at least 15 mol. %. Within the category of essentially unsaturated diene elastomers are highly unsaturated diene elastomers, which are diene elastomers having a content of units of diene origin (conjugated diene) that is greater than 50 mol. %.

Those diene elastomers that do not fall into the definition of being essentially unsaturated are, therefore, the essentially saturated diene elastomers. Such elastomers include, for example, butyl rubbers and copolymers of dienes and of alpha-olefins of the EPDM type. These diene elastomers have low or very low content of units of diene origin (conjugated dienes), such content being less than 15 mol. %.

The elastomers useful in the rubber compositions disclosed herein may have any microstructure, such microstructure being a function of the polymerization conditions used, in particular of the presence or absence of a modifying and/or randomizing agent and the quantities of modifying and/or randomizing agent used. The elastomers may, for example, be block, random, sequential or micro-sequential elastomers, and may be prepared in dispersion or in solution; they may be coupled and/or starred or alternatively functionalized with a coupling and/or starring or functionalizing agent.

Functionalized rubbers, i.e., those appended with active moieties, are well known in the industry. The backbone or the branch ends of the elastomers may be functionalized by attaching these active moieties to the ends of the chains or to the backbone or mid-chains of the polymer. Exemplary functionalizing agents that could be included with the diene elastomers include, but are not limited to, metal halides, metalloid halides, alkoxysilanes, imine-containing compounds, esters, ester-carboxylate metal complexes, alkyl ester carboxylate metal complexes, aldehydes or ketones, amides, isocyanates, isothiocyanates and imines—all of these being well-known in the art. Particular embodiments may include functionalized diene elastomers while other embodiments may be limited to including no functionalized elastomers.

Particular embodiments include at least 80 phr of a functionalized elastomer or alternatively at least 90 phr or 100 phr of a functionalized elastomer wherein the functional moiety interacts with the silica filler. Examples known in the art include silanol functional groups or polysiloxane functional groups having a silanol end (such as described, for example, in FR 2 740 778 or U.S. Pat. No. 6,013,718), alkoxysilane groups (such as described, for example, in FR 2 765 882 or U.S. Pat. No. 5,977,238), carboxyl groups (such as described, for example, in WO 01/92402 or U.S. Pat. No. 6,815,473, WO 2004/096865 or US 2006/0089445) or else polyether groups (such as described, for example, in EP 1 127 909 or U.S. Pat. No. 6,503,973), wherein each of these mentioned documents are hereby incorporated herein by reference.

Particular embodiments of the rubber compositions disclosed herein are limited to those having at least 80 phr of the rubber components being highly unsaturated diene elastomers. Other embodiments are limited to having at least 90 phr or 100 phr of the highly unsaturated diene elastomer components.

Examples of suitable highly unsaturated diene elastomers include, but are not necessarily limited to natural rubber (NR) and synthetic rubbers such as polybutadienes (BR), polyisoprenes (IR), butadiene copolymers, isoprene copolymers and mixtures of these elastomers. Such copolymers include butadiene/styrene copolymers (SBR), isoprene/butadiene copolymers (BIR), isoprene/styrene copolymers (SIR) and isoprene/butadiene/styrene terpolymers (SBIR). Any of these examples or mixtures of these examples are suitable for particular embodiments of the rubber compositions disclosed herein.

In particular embodiments, useful SBR elastomers may have a bound styrene content of between 1 mol % and 45 mol % or alternatively between 15 mol % and 40 mol % or between 20 mol % and 30 mol %. Particular embodiments of the rubber compositions disclosed herein include an SBR that is functionalized with a moiety that interacts with the silica filler, for example one or more of a silanol functional group or a polysiloxane functional group having a silanol end or an alkoxysilane group.

Particular embodiments of the rubber compositions disclosed herein include no essentially unsaturated diene elastomer and/or no essentially saturated diene elastomers. Alternatively particular embodiments may include between 1 phr and 10 phr of such elastomers or alternatively between 1 phr and 5 phr of such elastomers or no more than 10 phr or no more than 5 phr of such elastomers.

In addition to the rubber components described above, particular embodiments of the rubber compositions disclosed herein further include a silica reinforcement filler. It has been well known that as the volume fraction of filler is decreased in a rubber composition, extrusion becomes more difficult as the mix becomes more elastic in nature. Thus rubber formulations that are compounded for low rolling resistance applications, which typically are lower in filler, can be difficult to process. It is also known that the use of lower surface area fillers improve extrusion aspect due to better dispersion of the filler and the lower viscosity; however, wear resistance is usually degraded. Surprisingly the rubber compositions disclosed herein provide improved extrusion performance using a lower surface area silica filler but without any loss of wear performance while maintaining other key performances of rolling resistance and wet traction.

In other words, the rubber compositions disclosed herein provide a solution to the compromise between processability of the rubber composition and wear resistance of the cured rubber composition.

The silica useful in the rubber compositions disclosed herein have a surface area of between 100 m²/g and 135 m²/g or alternatively between 105 m²/g and 125 m²/g or between 110 m²/g and 120 m²/g, such surface area determined by nitrogen adsorption in accordance with ASTM D1993. Particular embodiments of the rubber compositions disclosed herein may further find useful silicas having the BET surface areas disclosed above and further having a CTAB surface area of between 100 m²/g and 135 m²/g or alternatively between 105 m²/g and 125 m²/g or between 110 m²/g and 120 m²/g, such surface area determined by CTAB adsorption in accordance with ASTM D6845.

Examples of useful silicas include ZEOSIL 1115MP available from Solvay and having a BET surface area of 115 m²/g and a CTAB surface area of 110 m²/g; HISIL EZ 120 available from PPG and having a BET surface area of 125 m²/g and a CTAB surface area of 125 m²/g; HISIL 315 available from PPG and having a BET surface area of 125 m²/g and a CTAB surface area of 125 m²/g; and ULTRASIL 5000 GR available from Evonik and having a BET surface area of 115 m²/g and a CTAB surface area of 110 m²/g.

The amount of the silica in particular embodiments of the rubber compositions disclosed herein is between 50 phr and 80 phr or alternatively between 55 phr and 70 phr of the silica.

The rubber compositions disclosed herein include little or no carbon black. Small amounts of carbon black may be added, for example, to color the tire black, such amounts being no more than 6 phr of carbon black or alternatively, no more than 4 phr or no more than 2 phr.

In addition to the rubber compositions and the silica as disclosed above, particular embodiments of the rubber compositions disclosed herein further include a silica coupling agent. Such coupling agents are well known and are at least bifunctional to provide a sufficient chemical and/or physical connection between the inorganic reinforcing filler and the diene elastomer. Examples of such coupling agents include bifunctional organosilanes or polyorganosiloxanes. Particular well known examples of coupling agents include 3,3′-bis(triethoxysilylpropyl)disulfide (TESPD) and 3,3′-bis(triethoxysilylpropyl)tetrasulfide (TESPT). It is noted that both TESPD and TESPT have sulfur as a component and their sulfur content contributes to the total amount of sulfur in the rubber composition that is available for the sulfur curing system. For example, TESPT is about 23% sulfur.

The amount of coupling agent added to particular embodiments of the rubber compositions disclosed herein may be between 7 wt % and 9 wt % of the total weight of the silica or alternatively between 7 wt % and 8 wt % of the total weight of the silica. For example if there is 68 phr of silica in a rubber composition, 7.5 wt % of the coupling agent would be 5.1 phr.

In addition to the rubber components and the silica as disclosed above, particular embodiments of the rubber compositions disclosed herein include a sulfur cure system. The sulfur cure system includes both sulfur and accelerators. The sulfur curing system may include free sulfur, sulfur from sulfur donors, sulfur from the silica coupling agents and may further include, for example, one or more of accelerators and curing activators such as stearic acid and zinc oxide. Suitable free sulfur includes, for example, pulverized sulfur, rubber maker's sulfur, commercial sulfur, and insoluble sulfur. As noted, particular embodiments may include no free sulfur added in the curing system but instead include in known way sulfur donors that provide sulfur to the rubber composition for curing.

Accelerators are used to control the time and/or temperature required for vulcanization and to improve the properties of the cured rubber composition. Particular embodiments of the present invention include one or more accelerators. One example of a suitable primary accelerator useful in the present invention is a sulfenamide. Examples of suitable sulfenamide accelerators include n-cyclohexyl-2-benzothiazole sulfenamide (CBS), N-tert-butyl-2-benzothiazole Sulfenamide (TBBS), N-Oxydiethyl-2-benzthiazolsulfenamid (MBS) and N′-dicyclohexyl-2-benzothiazolesulfenamide (DCBS). Combinations of accelerators are often useful to improve the properties of the cured rubber composition and the particular embodiments include the addition of secondary accelerators.

Particular embodiments may include as a secondary accelerant the use of a moderately fast accelerator such as, for example, diphenylguanidine (DPG), triphenyl guanidine (TPG), diorthotolyl guanidine (DOTG), o-tolylbigaunide (OTBG) or hexamethylene tetramine (HMTA). Such accelerators may be added in an amount of up to 4 phr, between 0.5 and 3 phr, between 0.5 and 2.5 phr or between 1 and 2 phr. Particular embodiments may exclude the use of fast accelerators and/or ultra-fast accelerators such as, for example, the fast accelerators: disulfides and benzothiazoles; and the ultra-accelerators: thiurams, xanthates, dithiocarbamates and dithiophosphates.

The amount of sulfur and accelerator included in the particular embodiments of the rubber compositions disclosed herein may be between 1 phr and 2 phr of sulfur or alternatively between 1 phr and 1.5 phr and enough accelerator to provide a curing system that has a sulfur to accelerator ratio by weight of between 0.4 and 0.6 or alternatively between 0.45 and 0.55 or between 0.4 and 0.55.

Other additives can be added to the rubber compositions disclosed herein as known in the art. Such additives may include, for example, some or all of the following: antidegradants, antioxidants, fatty acids, waxes, stearic acid and zinc oxide. Examples of antidegradants and antioxidants include 6PPD, 77PD, IPPD and TMQ and may be added to rubber compositions in an amount, for example, of from 0.5 phr and 5 phr. Zinc oxide and/or stearic acid, that are known to be sulfur curing activators, may each be added in an amount, for example, of between 0.5 phr and 6 phr or alternatively, of between 0.5 phr and 4 phr. Waxes may be added in an amount, for example, of between 1 phr and 5 phr.

The rubber compositions that are embodiments of the present invention may be produced in suitable mixers, in a manner known to those having ordinary skill in the art, typically using two successive preparation phases, a first phase of thermo-mechanical working at high temperature, followed by a second phase of mechanical working at lower temperature.

The first phase of thermo-mechanical working (sometimes referred to as “non-productive” phase) is intended to mix thoroughly, by kneading, the various ingredients of the composition, with the exception of the vulcanization system. It is carried out in a suitable kneading device, such as an internal mixer or an extruder, until, under the action of the mechanical working and the high shearing imposed on the mixture, a maximum temperature generally between 120° C. and 190° C., more narrowly between 130° C. and 170° C., is reached.

After cooling of the mixture, a second phase of mechanical working is implemented at a lower temperature. Sometimes referred to as “productive” phase, this finishing phase consists of incorporating by mixing the vulcanization (or cross-linking) system (sulfur or other vulcanizing agent and accelerator(s)), in a suitable device, for example an open mill. It is performed for an appropriate time (typically between 1 and 30 minutes, for example between 2 and 10 minutes) and at a sufficiently low temperature lower than the vulcanization temperature of the mixture, so as to protect against premature vulcanization.

The rubber composition can be formed into useful articles, including treads for use on vehicle tires. The treads may be formed as tread bands and then later made a part of a tire or they be formed directly onto a tire carcass by, for example, extrusion and then cured in a mold. As such, tread bands may be cured before being disposed on a tire carcass or they may be cured after being disposed on the tire carcass. Typically a tire tread is cured in a known manner in a mold that molds the tread elements into the tread, including, e.g., the sipes molded into the tread blocks.

It is recognized that treads may be formed from only one rubber composition or in two or more layers of differing rubber compositions, e.g., a cap and base construction. In a cap and base construction, the cap portion of the tread is made of one rubber composition that is designed for contact with the road. The cap is supported on the base portion of the tread, the base portion made of a different rubber composition. In particular embodiments of the present invention the entire tread may be made from the rubber compositions as disclosed herein while in other embodiments only the cap portions of the tread may be made from such rubber compositions.

It is recognized that the contact surface of a tread block, i.e., that portion of the tread block that contacts the road, may be formed totally from the rubber composition having the low Tg as disclosed herein, may be formed totally from another rubber composition or may be formed as combinations thereof. For example, a tread block may be formed as a composite of layered rubber compositions such that half of the block laterally is a layer of the low Tg rubber composition and the other half of the block laterally is a layer of an alternative rubber composition. Such construction would provide a tread block having 80 percent of its contact surface formed of the low Tg rubber composition.

As such, in particular embodiments of the present invention, at least 80 percent of the total contact surface of all the tread blocks on a tread may be formed from the rubber composition having the low Tg as disclosed herein. Alternatively, at least 90 percent, at least 95 percent or 100 percent of the total contact surface of all the tread blocks on a tread may be formed from such rubber composition.

While the tire treads disclosed herein are suitable for many types of vehicles, particular embodiments include tire treads for use on vehicles such as passenger cars and/or light trucks. Such tire treads are also useful for all weather tires, snow tires and/or warm weather tires. As such, the properties of the cured rubber compositions from which the treads disclosed herein may be manufactured may have a glass transition temperature of between −35° C. and −25° C. and/or alternatively, between −28° C. and −14° C., between −30° C. and −16° C. and/or between −16° C. and 10° C.

The invention is further illustrated by the following examples, which are to be regarded only as illustrations and not delimitative of the invention in any way. The properties of the compositions disclosed in the examples were evaluated as described below and these utilized methods are suitable for measurement of the claimed properties of the claimed invention.

The maximum tan delta and complex shear modulus dynamic properties for the rubber compositions were measured at 23° C. on a Metravib Model VA400 ViscoAnalyzer Test System in accordance with ASTM D5992-96. The response of a sample of vulcanized material (double shear geometry with each of the two 10 mm diameter cylindrical samples being 2 mm thick) was recorded as it was being subjected to an alternating single sinusoidal shearing stress at a frequency of 10 Hz under a controlled temperature of 23° C. Scanning was effected at an amplitude of deformation of 0.05 to 50% (outward cycle) and then of 50% to 0.05% (return cycle) or 1% to 100% back to 1% peak-to-peak. The maximum value of the tangent of the loss angle tan delta (max tan δ) was determined during the return cycle. The complex shear modulus G* was determined at 10%, 1% and 100% peak-to-peak strain during the return cycle.

Dynamic properties (G*60° C. and Tg) for the rubber compositions were measured on a Metravib Model VA400 ViscoAnalyzer Test System in accordance with ASTM D5992-96. The response of a sample of vulcanized material (double shear geometry with each of the two 10 mm diameter cylindrical samples being 2 mm thick) was recorded as it was being subjected to an alternating single sinusoidal shearing stress of a constant 0.7 MPa and at a frequency of 10 Hz over a temperature sweep from −80° C. to 100° C. with the temperature increasing at a rate of 1.5° C./min. The shear modulus G* was captured at 60° C. and the temperature at which the max tan delta occurred was recorded as the glass transition temperature, Tg.

Modulus of elongation (MPa) was measured at 10% (MA10) and at 100% (MA100) at a temperature of 23° C. based on ASTM Standard D412 on dumb bell test pieces. The measurements were taken in the second elongation; i.e., after an accommodation cycle. These measurements are secant moduli in MPa, based on the original cross section of the test piece.

The elongation property was measured as elongation at break (%) and the corresponding elongation stress (MPa), which is measured at 23° C. in accordance with ASTM Standard D412 on ASTM C test pieces.

Wear resistance of a tire mounted on an automobile was measured by subjecting the tire to actual on-road travel and measuring its wear rate (mm of tread lost per 1000 miles) at between 10,000 and 12,000 miles traveled. A value greater than that of the control, arbitrarily set to 100, indicates an improved result, that is to say less wear rate.

### EXAMPLE 1

Rubber compositions were prepared using the components shown in Table 1. The amount of each component making up the rubber compositions shown in Table 1 are provided in parts per hundred parts of rubber by weight (phr). The SBR was a functionalized SBR having a silanol end-of-chain functional group. The SBR used in W1 and F1 had a Tg of −48° C. with a styrene content of 26%. The SBR used in W2 and F2 was a mixture of 75 wt % of the SBR used in W1 and 25 wt % of an SBR that had a Tg of −65° C. and with a styrene content of 15%. The silica used in F1 and F2 was Ultrasil 5000 from Evonik.

TABLE 1
Formulations

| Components | W1 | F1 | W2 | F2 |
|---|---|---|---|---|
| SBR | 100 | 100 | 100 | 100 |
| N234 | 4 | 4 | 4 | 4 |
| Silica, 165 m²/g | 48 | | 55 | |
| Silica, 115 m²/g | | 58 | | 68 |
| Silane 69 | 4.8 | 4.4 | 5.5 | 5.1 |
| Processing Oil | 1.9 | 1.9 | | |
| Resin | 23.1 | 23.1 | 31 | 31 |
| Antidegradant Pkg | 4.9 | 4.9 | 3.5 | 3.5 |
| Stearic Acid | 2 | 2 | 2 | 2 |
| Zinc Oxide | 1 | 1 | 1 | 1 |
| Accelerators | 3.2 | 2.9 | 3.5 | 2.9 |
| Sulfur | 1.33 | 1.38 | 1.51 | 1.56 |
| AMO 070 | 2 | 2 | | |
| S/Acc | .42 | .48 | .43 | .53 |

TABLE 2
Physical Properties

| Physical Properties | W1 | F1 | W2 | F2 |
|---|---|---|---|---|
| Mooney (1 + 4), 100° C. | 87.6 | 85.9 | 104.7 | 104.1 |
| MA10 @23° C., MPa | 3.8 | 4.0 | 3.6 | 3.8 |
| MA100 @23° C., MPa | 1.7 | 1.8 | 1.7 | 1.8 |
| Break Stress @ 23° C., MPa | 23.6 | 22.7 | 25 | 22.7 |
| Strain at Break, % | 484 | 492 | 565 | 522 |
| Max Tan Delta @ 23° C. | 0.181 | 0.196 | 0.16 | 0.19 |
| G* @ 10%, 23° C., MPa | 1.66 | 1.94 | 1.62 | 1.74 |
| Tg, ° C. | −18.6 | −18.7 | −24.8 | −24.5 |

TABLE 3
Tire Testing

| Tire Results | W1 | F1 | W2 | F2 |
|---|---|---|---|---|
| Front Wear, Normalized | 95 | 99 | 95 | 100 |
| Rear Wear, Normalized | 115 | 123 | 112 | 118 |
| Dry Braking | 103 | 101 | 101 | 101 |
| Damp Braking | 114 | 118 | 93 | 95 |
| Wet Braking | 110 | 119 | 95 | 97 |

As can be seen from the results shown in Table 2 and Table 3, when comparing W1 and F1 and W2 and F2, there was a significant improvement in the tire wear results without an increase in Mooney viscosity as well as a significant increase in damp and wet braking.

The terms “comprising,” “including,” and “having,” as used in the claims and specification herein, shall be considered as indicating an open group that may include other elements not specified. The term “consisting essentially of,” as used in the claims and specification herein, shall be considered as indicating a partially open group that may include other elements not specified, so long as those other elements do not materially alter the basic and novel characteristics of the claimed invention. The terms “a,” “an,” and the singular forms of words shall be taken to include the plural form of the same words, such that the terms mean that one or more of something is provided. The terms “at least one” and “one or more” are used interchangeably. The term “one” or “single” shall be used to indicate that one and only one of something is intended. Similarly, other specific integer values, such as “two,” are used when a specific number of things is intended. The terms “preferably,” “preferred,” “prefer,” “optionally,” “may,” and similar terms are used to indicate that an item, condition or step being referred to is an optional (not required) feature of the invention. Ranges that are described as being “between a and b” are inclusive of the values for “a” and “b.”

It should be understood from the foregoing description that various modifications and changes may be made to the embodiments of the present invention without departing from its true spirit. The foregoing description is provided for the purpose of illustration only and should not be construed in a limiting sense. Only the language of the following claims should limit the scope of this invention.

1. A tire comprising a tire component, the tire component comprising a rubber composition based upon a cross-linkable rubber composition, the cross-linkable rubber composition comprising, in parts by weight per 100 parts by weight of rubber (phr):
100 phr of a rubber component selected from the group consisting of natural rubber, a synthetic rubber and combinations thereof, wherein the rubber component includes at least 90 phr of a synthetic rubber, which is functionalized with a moiety that interacts with a silica reinforcement filler;
between 50 phr and 80 phr of the silica reinforcement filler having a BET surface area of between 100 m²/g and 135 m²/g measured in accordance with ASTM D1993;
a silica coupling agent; and
a sulfur curing system comprising between 1 phr and 2 phr of sulfur and an accelerator in an amount to provide a ratio of the sulfur to the accelerator by weight of between 0.4 and 0.6.

2. The tire of claim 1, wherein the rubber component includes at least 80 phr of the synthetic rubber, which is functionalized with the moiety that interacts with the silica filler.

3. (canceled)

4. The tire of claim 2, wherein the rubber component includes 100 phr of the synthetic rubber, which is functionalized with the moiety that interacts with the silica filler.

5. The tire of claim 1, wherein the synthetic rubber is SBR functionalized with one or more of a silanol functional group, a polysiloxane functional group having a silanol end or an alkoxysilane group.

6. The tire of claim 1, wherein the synthetic rubber is selected from the group consisting of a polybutadiene, polyisoprene, a butadiene copolymer, an isoprene copolymer and combinations thereof.

7. The tire of claim 1, wherein the BET surface area is between 110 m²/g and 120 m²/g.

8. The tire claim 1, wherein a CTAB surface area of the silica reinforcing filler is between 100 m²/g and 135 m²/g.

9. The tire of claim 1, wherein the cross-linkable rubber composition comprises between 55 phr and 80 phr of the silica reinforcing filler.

10. The tire of claim 1, wherein the cross-linkable rubber composition comprises between 7 wt % and 9 wt % of the silica coupling agent based upon the of the total weight of the silica reinforcing filler.

11. The tire of claim 1, wherein the tire component is a tread.

12. The tire of claim 4, wherein the synthetic rubber is SBR functionalized with one or more of a silanol functional group, a polysiloxane functional group having a silanol end or an alkoxysilane group.

13. The tire of claim 12, wherein the BET surface area is between 110 m²/g and 120 m²/g.

14. The tire claim 13, wherein a CTAB surface area of the silica reinforcing filler is between 100 m²/g and 135 m2/g.

15. The tire of claim 14, wherein the cross-linkable rubber composition comprises between 55 phr and 80 phr of the silica reinforcing filler.

16. The tire of claim 15, wherein the cross-linkable rubber composition comprises between 7 wt % and 9 wt % of the silica coupling agent based upon the of the total weight of the silica reinforcing filler.

17. The tire of claim 16, wherein the tire component is a tread.
